(19) United States
(12) Patent Application Publication
(10) Pub. No.: US 2005/0154628 A1
(43) Pub. Date: Jul. 14, 2005

(54) Automated management of business performance information

(75) Inventors: Loren Eckart, Atlanta, GA (US); Robert Woosley, Atlanta, GA (US)

Correspondence Address: HUNTON & WILLIAMS, Suite 1200, 1900 K Street, N.W., Washington, DC, 20006-1109, US

(73) Assignee: Illumen, Inc., Atlanta, GA (US)

(21) Appl. No.: 10/830,115

(22) Filed: Apr. 23, 2004

Related U.S. Application Data
(60) Provisional application No. 60/535,801, filed on Jan. 13, 2004.

(51) Int. Cl. G06F 17/60

(52) U.S. Cl. 705/10

(57) ABSTRACT

The present invention provides systems and methods for obtaining, standardizing, aggregating, analyzing, reporting and delivering financial and operational information associated with one or more businesses. Business performance information having a user-defined format is obtained from a business and is standardized by mapping to a standard format, preferably using an automated process. Various analysis techniques may be performed on the converted business performance information and one or more performance reports and/or alerts may be generated and delivered. The standardized performance information also may be provided to requesting parties for additional processing. The present invention also provides a system and method for maintaining a database of aggregated, standardized business performance information from a plurality of businesses. Performance information from a particular business may be compared to representative performance metrics derived from the aggregated performance information to benchmark the performance of the particular business relative to similar businesses.

### CROSS-REFERENCE TO RELATED APPLICATIONS

The present application claims priority to U.S. Patent Application No. 60/535,801 (Attorney Docket No.: 59683.000002), filed Jan. 13, 2004 and entitled “Automated Business Financial Analysis and Reporting,” the entirety of which is incorporated by reference herein.

### FIELD OF THE INVENTION

The present invention relates generally to the processing of financial and operational data and more particularly to automating the standardization, aggregation, analysis and reporting of financial and operational data.

### BACKGROUND OF THE INVENTION

Most businesses employ accounting software programs to manage and compile financial information. Periodically, the financial information is supplied to an in-house or third party business advisor for analysis. The results of the analysis typically are supplied to the business and other interested parties as one or more performance reports.

Although the desire to have financial information analyzed on a periodic basis is universal, the format of the financial information submitted by businesses is not. The finances for a business typically are divided into a number of financial accounts represented in a general ledger. The accounts may be grouped by class, subclass, and so on. Absent strict guidelines or regulations, the definition and use of these accounts is relatively fluid and may be arranged to the classifications used by a particular business. For example, while one business may desire to lump all liquid assets into a general financial account “cash & cash equivalents,” it may be more suitable for another business to classify liquid assets by a number of separate accounts, such as, for example, a “cash” account, a “short term investments” account, and an “other” account. As another example, manufacturers often make use of the “cost of goods sold (COGS)” account, while this financial account may be unnecessary in certain service-oriented businesses. Recognizing this need for flexibility in organizing financial information, accounting software programs often allow users to define various financial accounts and subaccounts and to organize their financial information accordingly.

While making it easier for businesses to manage their financial information, this flexible approach often causes great difficulty to recipients of the financial information who are to process the financial information for various purposes. The performance analysis techniques used by business advisors typically are intended for implementation on financial information having a particular format. Thus, those business advisors who receive financial information from multiple businesses (or from multiple divisions from within the same business) often must contend with the daunting task of converting the financial information from the various user-defined formats to a particular standard format so that the various analytical techniques may be effectively applied to a broad and diverse group of businesses.

This problem is particularly acute for private, or closely-held, businesses as they often are not required to conform their accounting format to a particular standard, such as the Generally Accepted Accounting Principals (GAAP), or to various regulations set forth by regulatory bodies, such as the Securities Exchange Commission (SEC). Thus, while financial information from public companies frequently is relatively consistent as a result of its conformance to various regulatory standards, the formats employed by private businesses often diverge significantly from each other.

To make use of financial information having a particular format (“user-defined format” herein) used by a business, business advisors typically employ a spreadsheet program or similar software to manually convert financial information having a user-defined format to a standard format. This conventional spreadsheet method has a number of limitations. For one, this process typically results in the expenditure of considerable effort, as data is meticulously hand-copied from a file to a designated portion of a spreadsheet and then manually manipulated within the spreadsheet. Because many businesses typically provide financial or operational information in a non-electronic format (e.g., a hard-copy printout), these tasks typically involve considerable manual rekeying of the information, item by item, into one or more spreadsheets. It will be appreciated that this process is subject to a high probability of errors due to mistakes made while manually copying and manipulating the data in the spreadsheet. Furthermore, the resulting spreadsheet is often of limited utility as the spreadsheet typically is static and requires considerable effort to reorganize the spreadsheet to accommodate new analysis techniques. This manual process also frequently results in inconsistency between submissions of information as the format may be arbitrarily changed from submission to submission. This inconsistently can affect the accuracy of any analysis performed on the data and thus brings into question the quality of the information.

Accordingly, an improved technique for the automated processing of financial and/or operational information would be advantageous.

### SUMMARY OF THE INVENTION

The present invention mitigates or solves the above-identified limitations in known solutions, as well as other unspecified deficiencies in known solutions. A number of advantages associated with the present invention are readily evident to those skilled in the art, including economy of design and resources, transparent operation, cost savings, etc.

In accordance with one embodiment of the present invention, a method for automated management of performance information associated with at least one business is provided. The method comprises obtaining performance information associated with a business, the performance information having a first format based on a first set of performance classifications, converting, using an automated process, the performance information from the first format to a second format based at least in part on a mapping of one or more performance classifications of the first set of performance classifications to one or more respective performance classifications of a second set of standardized performance classifications, and analyzing the converted performance information based at least in part on one or more performance metrics.

In accordance with another embodiment of the present invention, a method for automated management of performance information associated with at least one business is provided. The method comprises obtaining performance information associated with a business as electronic data uploaded via a graphical user interface (GUI), the performance information having a first format based on a first set of performance classifications and converting, using at least one automated software program associated with the GUI, the performance information from the first format to a second format based at least in part on a mapping of the one or more performance classifications of the first set of performance classifications to one or more corresponding performance classifications of a second set of performance classifications. The method further comprises analyzing, using at least one automated software program associated with the GUI, the converted performance information based at least in part on one or more performance metrics and displaying one or more performance reports based on results of the analysis of the converted performance information via the GUI.

In accordance with yet another embodiment of the present invention, a system for automated management of performance information associated with at least one business is provided. The system comprises means for obtaining performance information associated with a business, the performance information having a first format based on a first set of performance classifications, automated means for converting the performance information from the first format to a second format based at least in part on a mapping of one or more performance classifications of the first set of performance classifications to one or more performance classifications of a second set of performance classifications, and automated means for analyzing the converted performance information based at least in part on one or more performance metrics.

In accordance with an additional embodiment of the present invention, a system for automated management of performance information associated with a at least one business is provided. The system comprises one or more networked servers adapted to operate a website having one or more webpages, obtain performance information associated with a business as electronic data uploaded via one or more webpages of the website, the performance information having a first format based on a first set of performance classifications, convert the performance information from the first format to a second format based at least in part on a mapping between one or more performance classifications of the first set of performance classifications to one or more respective performance classifications of the second set of performance classifications, analyze the converted performance information based at least in part on one or more performance metrics, and provide one or more performance reports of results of the analysis of the converted performance information for display via the one or more webpages of the website.

In accordance with an other embodiment of the present invention, a method for mapping business performance information having a first format based on a first set of performance classifications to a second format based on a second set of performance classifications is provided. The method comprises displaying a list of one or more performance classifications of the first set of performance classifications via a graphical user interface (GUI), displaying a list of one or more of performance classifications of the second set of performance classifications via the GUI, receiving user input indicating correlations between one or more of the displayed performance classifications of the first set of performance classifications and one or more of the displayed performance classifications of the second set of performance classifications and generating a conversion map for converting the business performance information from the first format to the second format based at least in part on the correlations indicated by the user input.

In accordance with yet another embodiment of the present invention, a system for mapping business performance information having a first format based on a first set of performance classifications to a second format based on a second set of performance classifications is provided. The system comprises means for displaying a list of one or more performance classifications of the first set of performance classifications on a graphical user interface (GUI), means for displaying a list of one or more of performance classifications of the second set of performance classifications on the GUI, means for receiving user input indicating correlations between one or more of the displayed performance classifications of the first set of performance classifications and one or more displayed performance classifications of the second set of performance classifications and means for generating a conversion map for converting the business performance information from the first format to the second format based at least in part on the corrlations indicated by the user input.

In accordance with an additional embodiment of the present invention, a method for providing a benchmark analysis of performance information associated with at least one business is provided. The method comprises converting performance information associated with each of a plurality of businesses to a first format, aggregating at least a portion of the converted performance information of each of the plurality of businesses, identifying one or more representative performance metrics representative of the plurality of businesses based at least in part on an analysis of the aggregated performance information and benchmarking performance information associated with a first business based at least in part on a comparison of the performance information associated with the first business with at least one of the one or more representative performance metrics.

In accordance with another embodiment of the present invention, a method for providing a benchmark analysis of performance information associated with at least one business is provided. The method comprises converting performance information associated with a first business from a first format based on a first set of performance classifications to a second format based on a second set of performance classifications, comparing the converted performance information with performance information associated with a second business and having the second format, wherein the second business has at least one business classification in common with the first business and generating one or more performance reports based at least in part on results of the comparison.

In accordance with yet another embodiment of the present invention, a system for providing a benchmark analysis of performance information associated with a business is provided. The system comprises a database having performance information associated with a plurality of businesses, the performance information having a first format based on a first set of performance classifications, automated means for identifying one or more representative performance metrics representing the plurality of businesses based at least in part on an analysis of the performance information of the database and automated means for benchmarking performance information associated with a first business based at least in part on a comparison of the performance information of the first business with at least one of the one or more representative performance metrics.

### BRIEF DESCRIPTION OF THE DRAWINGS

The purpose and advantages of the present invention will be apparent to those of ordinary skill in the art from the following detailed description in conjunction with the appended drawings in which like reference characters are used to indicate like elements, and in which:

FIG. 1 is a schematic diagram illustrating an exemplary automated system and process for the management of business performance information in accordance with at least one embodiment of the present invention.

FIG. 2 is a schematic diagram illustrating the exemplary automated system of FIG. 1 in greater detail in accordance with at least one embodiment of the present invention.

FIG. 3 is a flow diagram illustrating an exemplary method for automated management of business performance information in accordance with at least one embodiment of the present invention.

FIG. 4 is a schematic diagram illustrating an exemplary system for maintaining a database of business performance information for private companies in accordance with at least one embodiment of the present invention.

FIG. 5 is a flow diagram illustrating an exemplary method for maintaining a database of business performance information for private companies in accordance with at least one embodiment of the present invention.

FIG. 6 is a flow diagram illustrating an exemplary method for using a database of business performance information for a benchmark analysis in accordance with at least one embodiment of the present invention.

FIG. 7 is a schematic diagram illustrating a networked implementation of the exemplary system of FIG. 2 in accordance with at least one embodiment of the present invention.

FIG. 8 is a block diagram illustrating an exemplary site map of a business performance management website in accordance with at least one embodiment of the present invention.

FIGS. 9-15 are block diagrams illustrating exemplary webpages of the business performance management website of FIG. 8 in accordance with at least one embodiment of the present invention.

FIG. 16 is a flow diagram illustrating an exemplary method for configuring a conversion map used to convert business performance information from one format to another in accordance with at least one embodiment of the present invention.

FIG. 17 is a block diagram illustrating an exemplary implementation of an alert as an email in accordance with at least one embodiment of the present invention.

### DETAILED DESCRIPTION OF THE INVENTION

The following description is intended to convey a thorough understanding of the present invention by providing a number of specific embodiments and details involving automated performance analysis. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

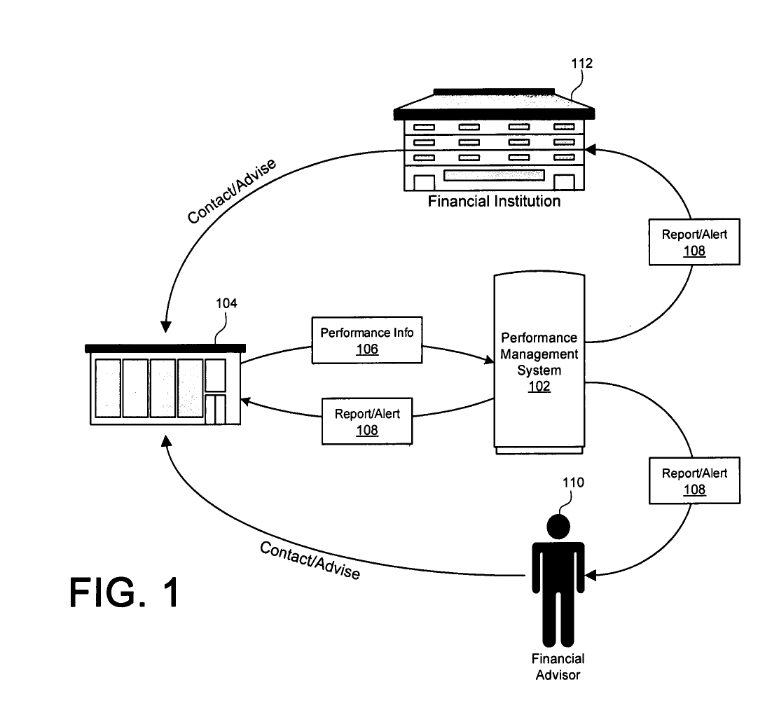

FIGS. 1-17 illustrate exemplary systems and methods for standardizing, aggregating, and analyzing business performance information originally having an arbitrary user-defined format, as well as for generating business performance reports based on the results of the analysis and delivering the reports and/or the standardized business performance information. Business performance information may include financial information related to the finances of a business, such as net operating income, days sales outstanding, and the like, and may include operational information related to the operation of a business, such as, for example, the number of stores, the average square footage of the stores, cycle times, number of customers served, etc. Business performance information further may include combinations of financial information and operation information, such as, for example, a stores annual net income per square foot of leased store space. In at least one embodiment of the present invention, business performance information having a user-defined format is provided by, or obtained from, an information submitting party (typically an owner, employee, agent or other representative of a business). Using a conversion mapping process, the business performance information is standardized by converting it from the user-defined format to a standard format. In at least one embodiment, the mapping of the business performance information is an automated process performed using one or more software programs. The standardized information then may be aggregated with standardized business performance information from other businesses based on any number of classifications. Various analysis techniques may be performed on the converted business information, either in aggregation or for a particular business, and one or more performance reports and/alerts may be generated from the results of the analysis. The analysis techniques and performance report generation also may be implemented as automated processes using one or more software programs.

Further, in at least one embodiment, the present invention provides a system and method for maintaining a database for storing standardized business performance information useful for benchmark analysis. Business performance information from a plurality of businesses may be converted from their particular user-defined formats to a standard format using one or more conversion maps. The standardized business performance information may be aggregated based on various classifications of the businesses. From a portion or all of the aggregated information, one or more performance metrics representative of the average or collective performance of the businesses may be identified. Business performance information from a particular business then may be compared to the representative performance metrics to benchmark the performance of the particular business relative to similar businesses.

The term performance metric, as used herein, generally refers to financial or operational classification c that are conventionally used to describe various classifications of the financial or operational performance of a business. A performance metric may include a raw metric represented, for example, as a financial account in the general ledger, such as a “cash” account, a “prepaid expenses” account, a “cost of labor” account, the square footage of a particular store, and the like, or an operational classification, such as employees per store, number of goods sold per store, etc. A performance metric also may include a derived metric that is a result of one or more business performance analysis techniques as applied to one or more raw metrics or other derived metrics. For example, the “total assets” metric may be considered a derived metric as it is calculated by summing the values associated with the accounts classified as asset accounts. Similarly, the “net profit (loss)” metric may be considered a derived metric, as it is typically determined as the difference between revenues and expenses for the identified period. Unless otherwise noted, the use of the term performance metric applies to both raw and derived metrics.

The term business performance management, as used herein, generally refers to any combination of the processes of: receiving business performance information in a user-specific format from a submitting party; standardizing the business performance information by converting it from the user-defined format to a standard format; aggregating standardized business performance information from any number of businesses; analyzing the standardized business performance information for an individual business or in aggregate; generating one or more performance reports or one or more alerts based at least in part on the standardized business performance information and/or the results of any analysis performed; transporting the business performance reports, alerts or various representations of the standardized business performance information to one or more requesting parties; or any of the number of additional processes described in detail herein. A submitting party typically includes an owner, employee, agent or other representative of a business who submits business performance information for processing as described below. A requesting party typically includes a party having an interest in the results of the manipulation of the business performance information submitted by the submitting party. Examples of requesting parties include a business advisor associated with the business, an insurer, a lending institution, a financial analyst, a credit rating agency, a regulatory agency, a certified public accountant (CPA), as well representatives of the business for which the information was submitted.

For ease of illustration, the present invention is described below in the context of the analysis of business performance information provided by private businesses. However, the exemplary systems and methods discussed herein may be adapted for analyzing business performance information related to other entities without departing from the spirit or the scope of the present invention. Indeed, the present invention could be implemented to analyze financial information related to public companies, non-profit organizations, government agencies, and the like. Also for ease of discussion, the present invention is described with emphasis on the financial aspect of business performance management. The exemplary systems and methods disclosed may be adapted for receiving, standardizing, aggregating, analyzing, reporting, alerting and transporting operation-related business performance information using the guidelines provided herein.

Referring now to FIG. 1, an exemplary automated business performance management system and process is illustrated in accordance with at least one embodiment of the present invention. As noted above, businesses often utilize an in-house or third party business advisor, such as a certified public accountant (CPA) or auditor, to examine the business performance information of the business in order to prepare tax filings, to ensure compliance with regulations, and/or to identify any areas of concern. As also noted above, the business advisor often must manually convert or rekey the business performance information (conventionally provided by the business in hard-copy form) from a particular user-defined format used by the business into a standard format that allows for meaningful analysis. After analyzing the converted business performance information, the business advisor typically provides one or more performance reports to the business or other requesting party, where the performance reports often are provided in hard-copy form or as a spreadsheet file. The business advisor often may provide a copy of the performance report to other requesting parties, such as a lender bank, that have dealings with the business. This conventional process involves considerable manual effort and is time consuming, resulting in a delay of days, and often weeks, between the submission of business performance information and the provision of a performance report detailing the results of the analysis of the business performance information.

At least one embodiment of the present invention overcomes the limitations of conventional performance analysis methods by providing an automated business performance management system 102 adapted to receive business performance information, standardize the business performance information by converting it from a user-defined format to a standard format, aggregate some or all of the standardized business performance information, analyze the standardized business performance information, and/or provide one or more performance reports and/or alerts resulting from the analysis in an automated process. The system 102 further may provide for the delivery of the performance reports, alerts, and/or the standardized business performance information to a requesting party in any of a variety of proprietary or well-known hard-copy or electronic formats.

A business 104, or a representative of the business 104, provides business performance information 106 to the performance management system 102. The business performance information 106 may be provided in a raw format or may be arranged in any of a variety of performance reporting formats, such as ledgers, income statements, balance sheets, operation specifications, etc. Preferably, the business performance information 106 is provided in electronic form and in a format used by any number of conventional accounting or business operation software programs. In other embodiments, however, the business performance information 106 may be provided in hard-copy format (e.g., a print out of the general ledger, income statement, balance sheet and/or cash flow statement), and the information represented on the hard copies may be converted to electronic form by the performance management system 102 by manual entry or by using an optical character recognition (OCR) process.

Upon receipt of the business performance information 106, the performance management system 102 converts the business performance information 106 from the particular user-defined format to a standard format using a conversion mapping process. This conversion process is discussed in greater detail below. With the business performance information 106 in a standard format, the performance management system 102 may analyze the business performance information 106 and generate at least one performance report 108 from the results of the analysis. The performance report 108 then may be provided to a requesting party, such as the business 104 or a business advisor 110 for review. Moreover, the business may have a relationship with, for example, a financial institution 112 or CPA, wherein the financial institution 112 or CPA is permitted to, or required to, periodically review the financial status of the business 104. For example, the business 104 may have taken a loan from a bank (one example of the financial institution 112) and agreed to permit the bank to periodically review the financial status of the business 104 as one of the conditions of the loan. In another example, the financial institution 112 may include a government regulatory agency to which the business 104 is required to periodically provide financial or operational information. It should be noted that although the performance management system 102 is illustrated as separate from the business advisor 110 and the financial institution 112, the performance management system 102 may be managed by, or operated on behalf of, either the a requesting party, such as the business advisor 110 or the financial institution 112. Additionally, the business advisor 110 may be an employee or other representative of the financial institution 112.

The performance report 108 may include a presentation of the business performance information 106 in a number of formats, such as a general ledger, an income statement, a balance sheet, a cash flow statement, a detailed operation report and the like. Additionally, the performance report 108 may include any of a variety of well-known techniques for providing detailed performance analysis results. For example, the performance report 108 may include one or more tables or charts detailing a history of one or more financial or operational metrics, such as, for example, a historical trend chart detailing the net income for the business 104 for the current period and a number of previous periods. As another example, the performance report 108 may include tables or charts comparing one or more performance metrics of the current period with the corresponding performance metrics of a previous period. In at least one embodiment, the performance report 108 further includes alert indicators (e.g., graphical icons) that may be used to quickly identify certain report items that warrant greater scrutiny. The alert indicators preferably are utilized to identify those performance metrics that diverge from the corresponding performance metrics from a previous period by more than a threshold amount, that diverge from a performance metric representative of an industry standard by more than a threshold amount, or that diverge from a target set for the corresponding performance metric by more than a threshold amount.

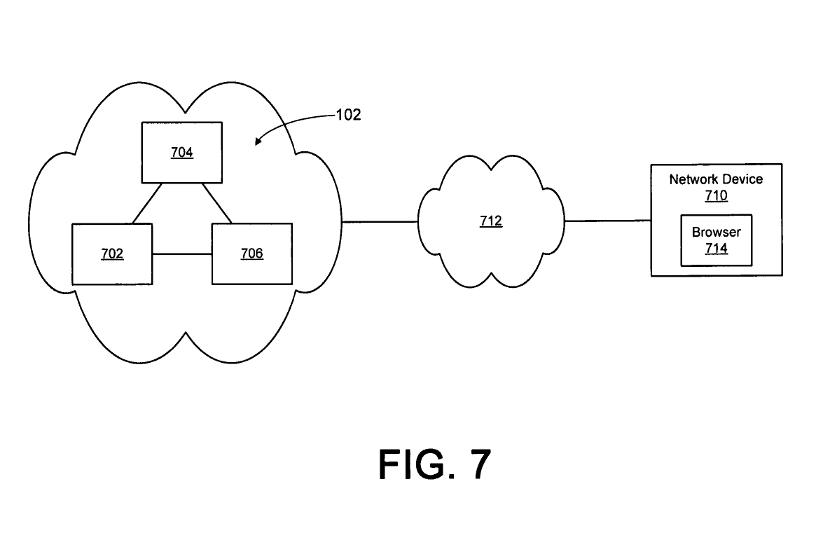

In at least one embodiment, one or more performance reports 108 are provided to the business 104, the business advisor 110 and/or financial institution 112 in electronic form via a graphical user interface (GUI). As described in greater detail with reference to FIGS. 7-16, the performance management system 102 may implement one or more networked data servers adapted to provide performance reports 108 and other information in a web-based format (e.g., as hyper-text markup language (HTML) documents) and the GUI may be implemented as a web browser used by a requesting party (e.g., the business advisor 110, a representative of the business 104 or the financial institution 112) to interface with the data server to display the performance reports as web pages and to receive user input.

The same performance report 108 may be provided to requesting party, or each requesting party may receive a different performance report 108 based on particular preferences or requirements. To illustrate, the business 104 may be interested only in its current financial status, and therefore the performance report 108 provided to the business 104 may include, for example, an income statement, a balance sheet and a cash flow statement for the current period only. The business advisor 110, however, may be interested not only in the current financial status of the business 104, but also in a comparison of the current financial status with one or more previous periods. Thus, the performance report 108 provided to the business advisor 110 also may include, for example, charts and graphs detailing a trend analysis for one or more financial metrics.

The performance report 108 may be used by the business advisor 110 or other requesting party to review the performance of the business 104. From this review, the requesting party may contact the business 104 to advise the business 104 or to offer additional services to the business 104 with the intent to correct or improve the performance of the business 104. For example, the performance report 108 provided to the business advisor 110 may indicate that the cash reserves available to the business 104 have steadily declined, so the business advisor 110 may contact the business 104 and advise the business 104 on methods to rebuild its cash reserves. In another example, the financial institution 112, acting as a lender to the business 104, may notice from the performance report 108 that the debt-to-asset ratio is nearing the threshold ratio that would place the business 104 in default under its loan agreement with the financial institution 112. Using this information, the financial institution 112 may contact the business 104 to inform it of its perilous position and request that the business 104 take corrective action.

By converting business performance information to a standard format, analyzing the business performance information, and generating one or more performance reports 108 using an automated process, the performance management system 102 can assist requesting parties in their review of the performance of the business 104 in a fraction of the time required by conventional techniques. As a result, there may be a tremendous cost savings on an on-going basis. Moreover, this quick turnaround facilitates the identification of problems while they are in a formative stage, thereby allowing them to be corrected before they become unmanageable. To illustrate, conventional performance analysis techniques may take weeks to turn around due to the manual effort involved in converting business performance information to a standard format that can be analyzed in a consistent and meaningful way, in addition to the time needed to generate the performance reports from the analysis. Thus, a business having a rapid decline in its cash account and a rapid increase in its accounts payable may find itself unable to make debt payments and payments to its trade accounts if a number of weeks passed before this condition was realized. However, because the performance management system 102 may provide meaningful analysis within minutes, or even seconds, of receiving business performance information from a business, such situations may be quickly identified and rectified.

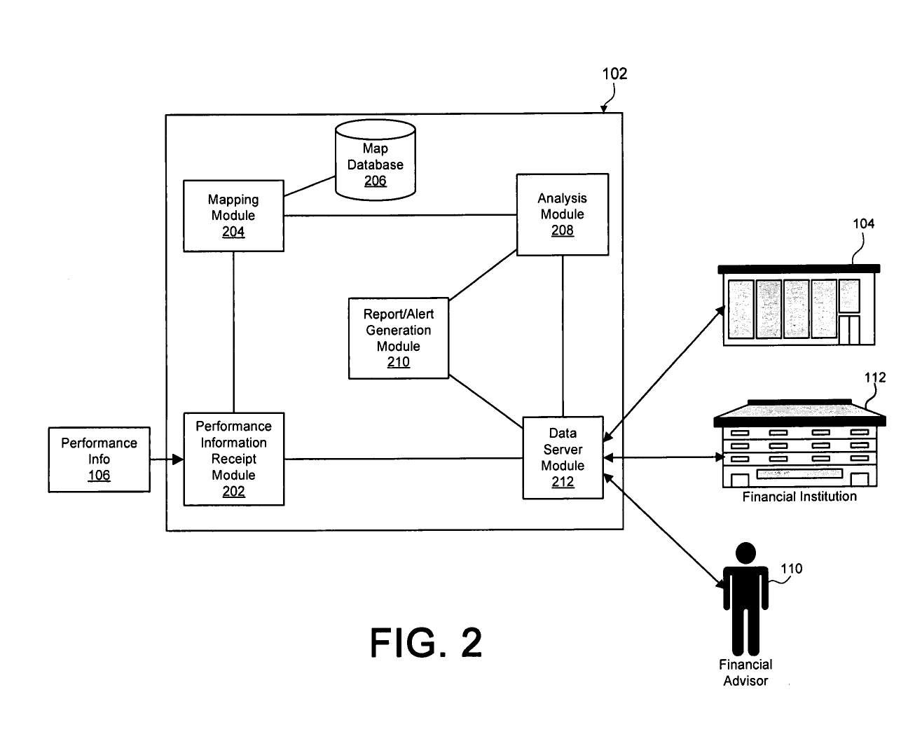

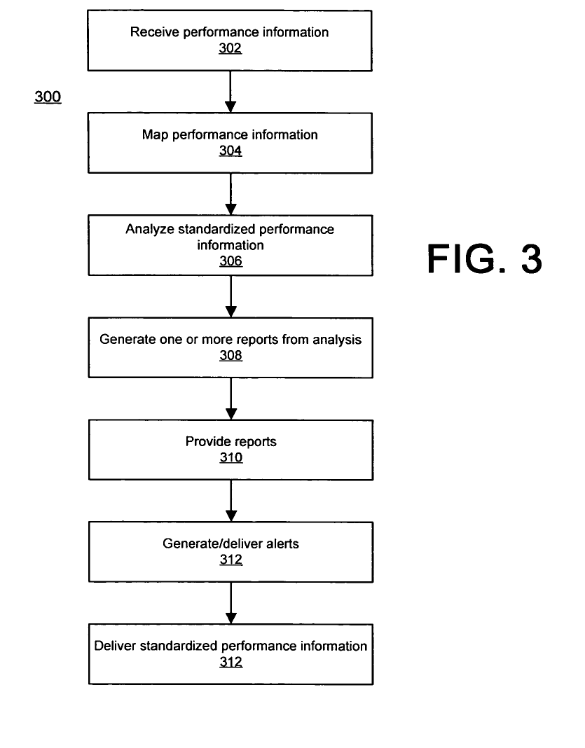

Referring now to FIGS. 2 and 3, an exemplary implementation of the performance management system 102 and an exemplary method 300 of its operation are illustrated in accordance with at least one embodiment of the present invention. In the illustrated example of FIG. 2, the performance management system 102 includes a performance information receipt module 202, a mapping module 204, a map database 206, an analysis module 208, a performance report/alert generation module 210, and a data server module 212. The modules 202-212 may be implemented in software, hardware, firmware, or a combination therein. In a preferred embodiment, the modules 202-212 are implemented in one or more software programs executed by one or more networked servers, as illustrated with reference to FIG. 7. The software programs may include custom programmed software and/or off-the-shelf software.

An exemplary operation of the modules 202-212 is described in conjunction with the exemplary method 300 of FIG. 3. Method 300 initiates at step 302 wherein the performance information receipt module 202 receives business performance information 106 from business 104. The business performance information 106 may be obtained from the business 104 in any of a variety of ways. To illustrate, business performance information 106 may be provided in electric form via email or a file transfer protocol (FTP) process, or the business performance information 106 may be uploaded by a representative of the business 104 via a webpage maintained by the performance management system 102. In such instances, the performance information receipt module 202 may be adapted to receive the electronic data representative of the business performance information 106 and store the data to a local disk or memory. In certain instances, the business performance information 106 may be encrypted to ensure confidentiality. The performance information receipt module 202 therefore may be adapted to decrypt encrypted business performance information 106.

As noted above, the business performance information 106 may have a user-defined format particular to the preferences of the business 104 supplying the information, whereas the performance analysis techniques applied to the business performance information 106 may be ineffective or inaccurate unless the business performance information to be analyzed is compiled in a standard format. Accordingly, at step 304, at least a portion of the business performance information 106 may be provided to the mapping module 204 for conversion to a standard format. In at least one embodiment, the mapping module 204 utilizes a conversion mapping process associated with the business 104 to convert the format of the business performance information 106 to a standard format. This conversion mapping process preferably implements a map or other data structure which represents a correlation between a user-defined performance classification (e.g., a user-defined financial account or operational classification) of the business performance information 106 in its original format and a corresponding performance classification (e.g., a standard financial account or operational classification) of the standard format. Thus, when converting the business performance information 106 from a user-defined format to the standard format, the mapping module 204 may use the conversion map to associate the values of user-defined performance classifications with the corresponding standard performance classifications.

Multiple user-defined performance classifications may be associated with a single standard performance classification. In such instances, the net sum of the values of the multiple user-defined performance classification may be associated with the single standard performance classification. To illustrate, the business 104 may be a package shipping company that uses trucks extensively to carry out its deliveries. As such, the business 104 may track the depreciation of its trucks separately from the depreciation of all other assets. The business performance information 106 from the business 104 may have a financial account related to the depreciation of the trucks over the period (the “truck depreciation” account) and another financial account related to the depreciation of all other assets for the same period (the “other assets depreciation” account). The performance management system 102, however, may be arranged to analyze financial information under the assumption that all asset depreciation is represented by a single financial account. Thus, for this example, the conversion map may include an indication of a correlation of the “truck depreciation” account and the “other assets depreciation” account to a single combined “asset depreciation” account for the standard format. Accordingly, when the business performance information 106 from the package delivery company is mapped to the standard format, the net sum of the values associated with the truck depreciation account and the other assets depreciation account may be associated with the “asset depreciation” account of the standard format.

In at least one embodiment, the performance management system 102 is used to analyze business performance information from a variety of businesses and therefore receives business performance information in a variety of particular formats. Accordingly, the mapping module 204 may have access to a map database 206 used to store conversion maps for a number of businesses. To map the business performance information 106 for a particular business, the mapping module 204 may obtain the conversion map associated with the business from the map database 206 and use the conversion map to convert the business performance information 106.

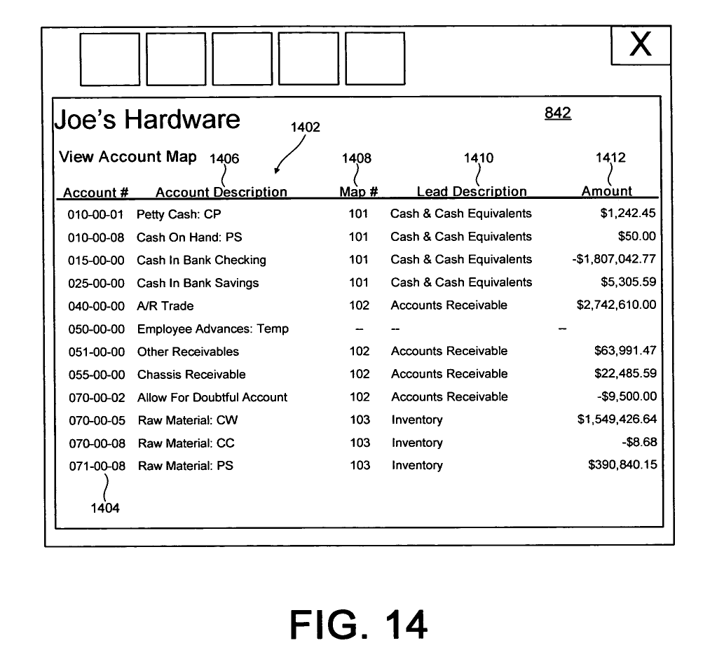

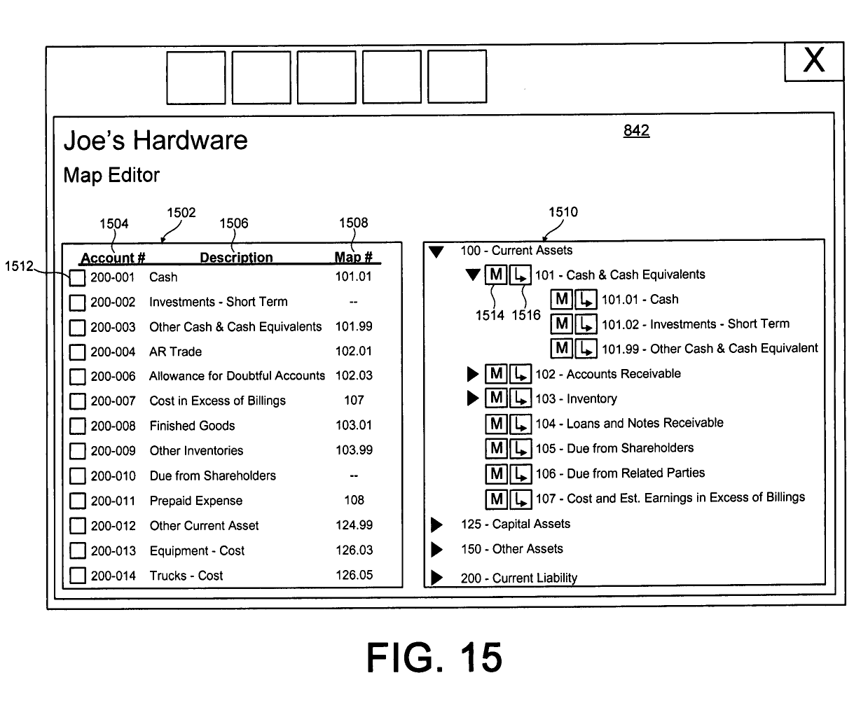

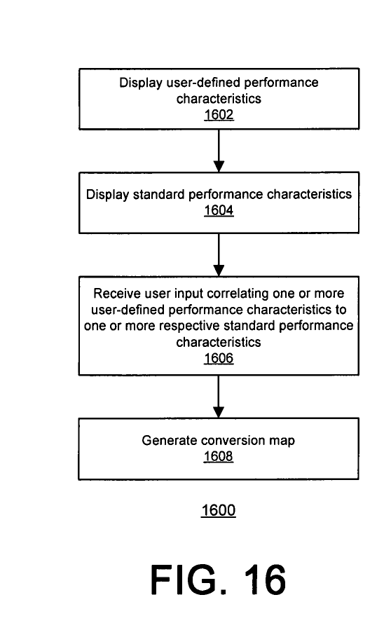

The conversion map associated with the business 104 may be implemented in a variety of forms. For example, the conversion map may be implemented in a data file as a table or other pairing of an identifier of a user-defined performance classification with the identifier of the corresponding standard performance classification. Using the above example, the business 104 may have assigned account number 110-01 to the “truck depreciation” account and account number 110-02 to the “other assets depreciation” account, whereas the “asset depreciation” account of the standard format is assigned an account number of, for example, 125.05. Therefore, the conversion map in this example may include a pair listing of (110-01, 125.05) and (110-02, 125.05), thus indicating to the mapping module 204 that the values associated with the user-defined accounts identified by account numbers 110-01 and 110-02 should be associated with the standard account identified by account number 125.5. Alternately, links between user-defined performance classification identifiers and standard performance classification identifiers may be used to create executable software programmed to specifically convert performance information from the particular format to the standard format, where the executable software represents the conversion map. To illustrate, the conversion map associated with the business 104 may be implemented as, for example, a software plug-in executed by the mapping module 204. Accordingly, the mapping module 204 may select and execute the appropriate software plug-in to convert performance information having a user-defined format associated with the software plug-in to the standard format. An exemplary implementation of a conversion map is illustrated in greater detail below with reference to FIG. 14. An exemplary process for creating a conversion map is illustrated below with reference to FIGS. 15 and 16.

At step 306, the converted business performance information 106 is analyzed by the analysis module 208. The analysis module 208 may be adapted to perform any of a variety of performance analysis techniques, including, for example, identification, evaluation and computation of performance metrics, trend analysis of performance metrics, benchmarking of performance metrics based on comparisons to peer businesses, and the like. The analysis further may include one or more portfolio-based scenario analysis run on the aggregated standardized business performance information from one or more businesses, an entire industry, and the like. For example, the converted business performance information 106 may be used to predict the future performance of a business or industry in the event that interest rates decline.

At step 308, the performance report/alert generation module 210 generates at least one performance report (e.g., performance report 108, FIG. 1) based at least in part on the results generated by the analysis module 208 at step 306. The performance report may include a variety of information related to the financial and/or operational performance of the business 104, such as, for example, a summary of key financial and operational metrics (e.g., total revenue, net income, the debt-to-equity ratio, goods sold per store, etc.), tables or charts detailing the historical performance of performance metrics, a comparison of various performance metrics with performance metrics with one or more previous periods or cycles, benchmark comparisons of various performance metrics to the corresponding performance metrics of peer businesses or an industry standard, and the like.

The performance report further may include one or more alert indicators associated with certain performance report items, where the alert indicators are intended to cause a reviewer of the performance report to analyze the corresponding performance report items in greater detail. The alert indicator may be used to identify those performance report items that reflect positively on the performance of the business 104, as well as those performance report items that reflect negatively on business performance. In at least one embodiment, an alert indicator may be used when a change in the performance metric from a previous period exceeds a certain threshold or when the performance metric varies from a predetermined value by a certain threshold, where the predetermined value may represent an industry standard value or a target value prescribed by, for example, the business 104 or a lender as part of a loan agreement with the business 104.

To illustrate, the analysis module 208 may be adapted to monitor the net profit of the business 104 on a quarterly basis. Should the change in the net profit exceed the change threshold associated with the net profit (a change of more than 15%, for example) from one period to the next, the performance report/alert generation module 210 may set an alert indicator next to the listing of the net profit in the performance report. A reviewer of the performance report is likely to notice the alert indicator and consider the consequences of the significant rise or fall in the net profit. As another example, the business 104 may be in an industry where it is preferable to maintain a debt-to-asset ratio of no more than 1.0. Thus, the analysis module 208 could be adapted to monitor the debt-to-asset ratio of the business 104 and the performance report/alert generation module 210 may set an alert indicator when the debt-to-asset ratio varies from a value of 1.0 by more than a particular threshold (20%, for example).

At step 310, the one or more performance reports generated by the performance report/alert generation module 210 are provided to, or made available for access by, a requesting party, such as the business 104, the business advisor 110 and/or the financial institution 112. As noted above, in at least one embodiment, the performance reports preferably are provided via a website maintained by the performance management system 102. Accordingly, the performance management system 102 may implement a data server module 212 adapted to process requests for information from requesting parties. To illustrate, the business 104, business advisor 110 or the financial institution 112 may employ a web browser to request one or more webpages (e.g., HTML files) representative of a performance report using, for example, a hypertext transfer protocol (HTTP) request. The data server module 212, upon receipt of the HTTP request, locates the requested webpages and transmits the webpages to the web browser for display. The provision of performance reports and other performance information via a website is discussed in greater detail below with reference to FIGS. 7-15.

In other embodiments, the performance reports generated by the performance report/alert generation module 210 may be provided by the data server module 212 in other electronic formats via email, FTP, and the like. The electronic format may include, for example, a spreadsheet file for display using spreadsheet software, as a word document for display using word processing software, and the like. Rather than sending the one or more performance reports in electronic format, a hard copy may be provided.

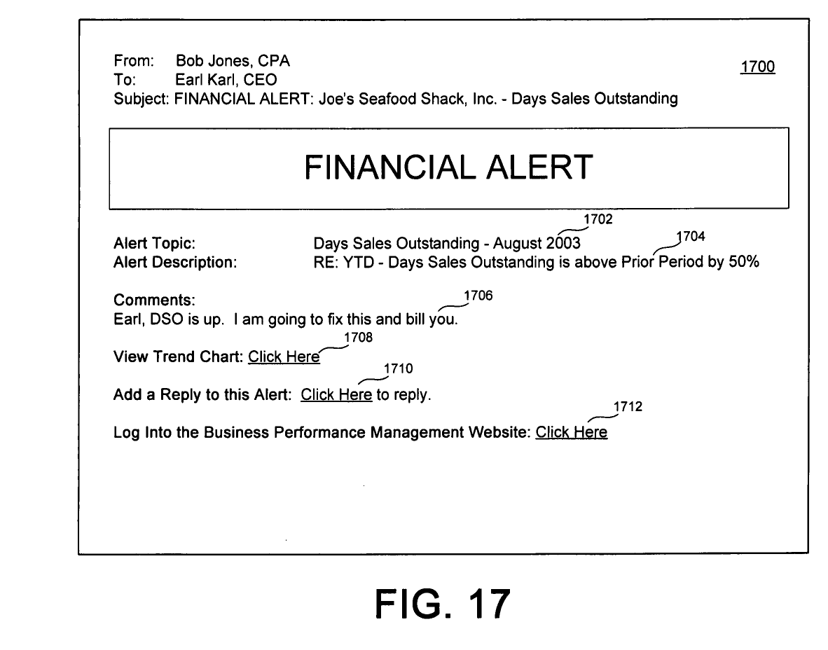

In addition to, or instead of, including alert indicators in one or more performance reports, at step 312 the report/alert generation module 210 may generate one or more alerts intended to inform a requesting party of one or more items of concern. The one or more alerts then may be provided to a requesting party via email, facsimile, an FTP transfer, an automated voice mail recording, text messaging, and the like. An exemplary implementation of an alert as an email message is discussed below with reference to FIG. 17.

In certain instances, a requesting party may be interested in receiving the standardized business information, or a portion thereof, for any of a variety of purposes. Accordingly, at step 314, the data server module 212 may identify the information to be provided to the data requester and include the identified information in one or more data files having a proprietary or well-known format designated by the data requester. For example, some or all of the standardized business performance information from the business 104 (or from an aggregation of businesses) may be inserted or otherwise configured in, for example, a data file formatted for operation with one or more industry-standard financial accounting systems, such as the PEACHTREE Premium Accounting Software available from Best Software SB, Inc. of Irvine, Calif. The one or more data files may be transported to the requesting party via email, an FTP transfer, mail, download from a website provided by the system 102, and the like.

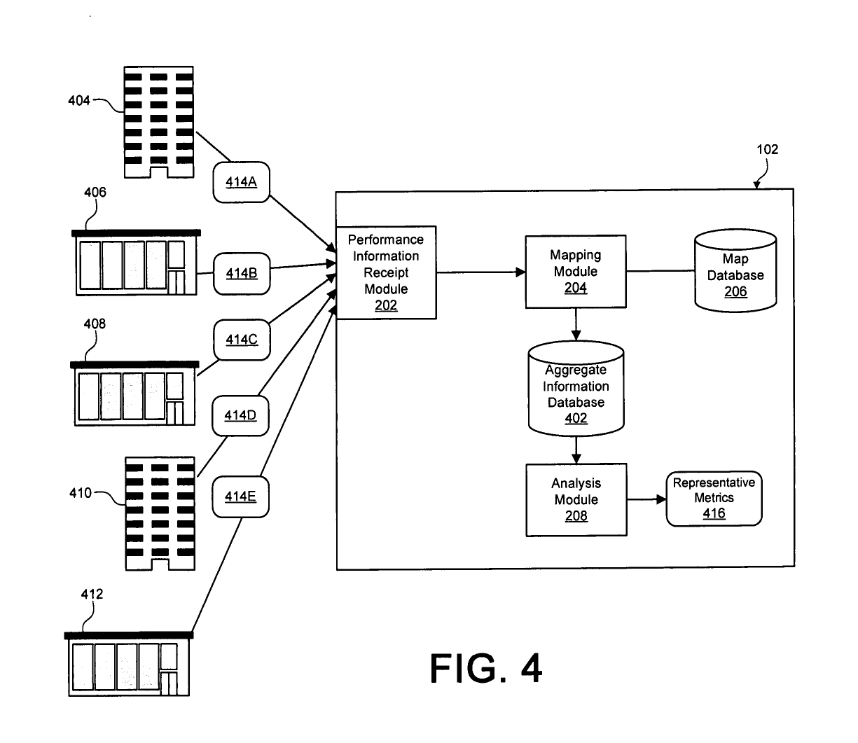

Referring now to FIGS. 4-6, an exemplary system and method for maintaining a database of aggregate business performance information from a plurality of private businesses is illustrated in accordance with at least one embodiment of the present invention. Although FIGS. 4-6 are described in the context of private businesses, the present invention may be implemented for other entities using the teachings provided herein.

As noted above, the analysis module 208 may be adapted to perform benchmarking by comparing the business performance information of a business with the corresponding business performance information of a peer business or with performance information representative of the mean or median of a group of peer businesses. The analysis module 208 therefore typically needs access to an aggregation of performance information of peer businesses to perform this benchmarking. Business performance information may be relatively easy to obtain for public companies, as public companies generally are required to periodically submit financial statements to various regulatory bodies, such as the SEC. The submitted financial statements then may be made available to the public by the regulatory bodies. Additionally, public companies often make the financial information available to investors and prospective investors.

In many situations, the performance management system 102 is employed to analyze the performance of private businesses. Benchmarking the performance of a private business to peer private businesses often provides the most meaningful information. However, private companies, unlike their public counterparts, generally are not required to make their financial or operational information available to the public, and private businesses therefore typically do not publicize this information. As a result, a number of financial reporting entities have attempted to provide private business benchmark standards for a variety of industries. However, these attempts share a significant limitation in that the information provided by a private business typically is in a format particular to the private business and the resulting benchmark values often are skewed and inaccurate as a result of the non-conformance of the financial information to an expected standard format.

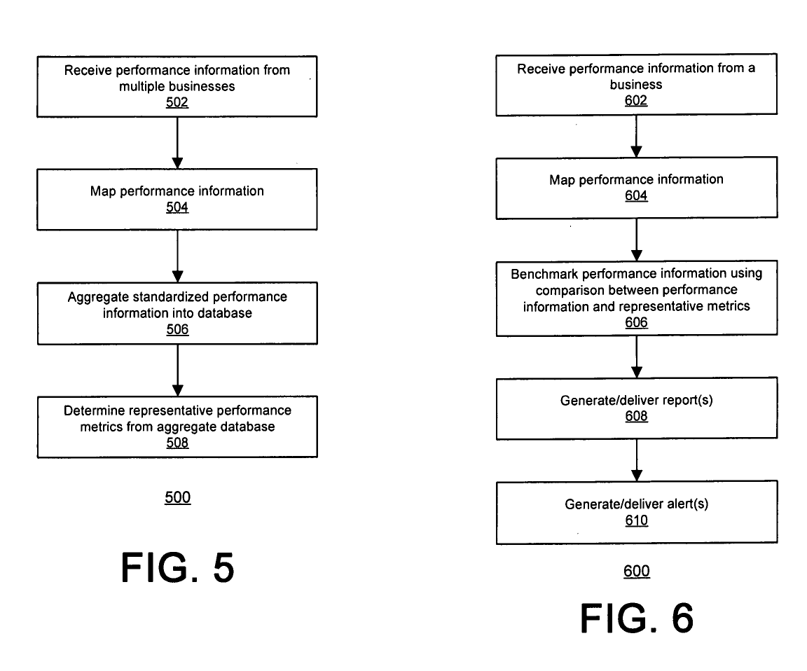

To overcome this limitation, in at least one embodiment, the performance analysis module 102 is adapted to maintain an aggregate information database 402 for storing business performance information provided by a plurality of private businesses, whereby the business performance information submitted by a private business is converted to a standard format by the mapping module 204 before inclusion in the aggregate information database 402. FIG. 5 illustrates an exemplary method 500 for maintaining the aggregate information database 402.

Exemplary method 500 initiates at step 502 wherein one or more submitting parties submit performance information 414A-414E related to businesses 404-412, respectively, to the performance analysis module 102 via the performance information receipt module 202. After receiving performance information from a private business, the performance information is converted from its user-defined format to a standard format by the mapping module 204 using a conversion mapping process associated with the private business (accessed, for example, from the map database 206) at step 504. Step 504 may be repeated for the performance information received for each of the plurality of private businesses 404-412.

In many instances, business performance information provided by a business may be pooled or aggregated with information from other businesses. Accordingly, in at least one embodiment, the business performance information provided by a business may be redacted or otherwise modified to remove some or all identifying information, such as account names, account numbers, and references to the business name, from the information. The information therefore may be pooled with information from other businesses in an anonymous fashion.

At step 506, some or all of the standardized performance information is inserted into the aggregate information database 402. The aggregate information database 402 may be organized into a number of categories or sub-databases. For example, private businesses may be categorized by size (as measured by employees, revenue, assets, etc.), industry type and/or subtypes, business entity type, stage of maturity, geographic location, and the like. Thus, the converted business performance information may be associated with the various categories or sub-databases when added to the aggregate information database 402.

At step 508, the analysis module 208 may identify various representative performance metrics 416 from the aggregate information database 402. The representative performance metrics 416 may be identified for any number or combination of financial accounts or operational performance classifications. For example, to perform a benchmark analysis of the net profit of a dry cleaning business having fewer than one hundred employees and operating in California, appropriate representative indicators 416 for this benchmark analysis may include, for example, the average net profit for all dry cleaning businesses represented in the aggregate information database 402. More preferably, the representative performance metrics 416 for this benchmark analysis may include the average net profit for all dry cleaning businesses having less than 100 employees represented in the aggregate information database 402. Even more preferably, the representative performance metrics 416 for this benchmark analysis may include the average net profit for all dry cleaning businesses having less than 100 employees and operating in California that are represented in the aggregate information database 402.

FIG. 6 illustrates an exemplary method 600 for performing a benchmark analysis of the performance of a private business as compared to one or more peer private businesses. The method 600 preferably is implemented as part of the performance analysis performed by the performance management system 102 as described with reference to method 300 of FIG. 3. The method 600 initiates at step 602 (analogous to step 302, FIG. 3), wherein business performance information is received from a private business by the performance information receipt module 202 (FIG. 2). At step 604 (analogous to step 304, FIG. 3), the business performance information is standardized by converting it to a standard format at the mapping module 204, as described above.

At step 606, one or more performance metrics of the performance information are benchmarked by comparing the one or more performance metrics with the corresponding representative performance metrics 416. In at least one embodiment, the representative performance metrics 416 used to benchmark the private business are identified from the performance information of a single peer private business. In this instance, the analysis module 208 may be adapted to identify the private business represented in the aggregate information database 402 that is most similar to the private business being benchmarked (i.e., the businesses have one or more business classifications in common). For example, assuming the private business being benchmarked is a coffee shop with less than 10 employees and operates in Texas, the analysis module 208 may search for another coffee shop in Texas having a similar number of employees. If such a business is not represented in aggregate information database 402, the analysis module 208 may broaden the scope of its search by broadening one or more of the classifications associated with the private business, such as, for example, by searching for any coffee shop in Texas, any coffee shop having the similar number of employees, etc. The analysis module 208 may continue to broaden the scope of its search until a suitable peer business is found.

In other embodiments, a private business is compared against a set of peer businesses. As with the single peer business scenario above, the analysis module 208 may vary the scope of its search until a suitable number of peer businesses are identified. After identifying appropriate peer businesses, the analysis module 208 may identify appropriate representative performance metrics by, for example, determining the mean or median value of one or more performance metrics for all of the selected peer businesses.

At step 608, the performance reporting module 210 may generate one or more performance reports based on the results of the benchmark analysis and the performance reports may be provided to one or more requesting parties. Moreover, should the variance between a performance metric of the private business being benchmarked and the corresponding representative performance metric exceed a certain threshold, an alert indicator may be included in the one or more performance reports or an alert may be sent at step 610 to alert a reviewer to this significant variance.

Referring now to FIG. 7, an exemplary networked implementation of the performance management system 102 is illustrated in accordance with at least one embodiment of the present invention. In the illustrated example, the performance management system 102 is implemented as one or more one or more networked servers 702-706. In one embodiment, the functions of the modules 202-212 (FIG. 2) are distributed among the servers 702-706. Alternatively, the functions may be duplicated across the servers 702-706 for redundancy purposes or to service a high volume of activity. A user (e.g., submitting party or requesting party), may access the one or more server 702-706 using a network device 710 connected via network 712, where the network device 710 may use a web browser 714 to upload business performance information or to access performance reports. The network device 710 may include any of a variety of processing devices capable of displaying information and transmitting and receiving input. Examples of the network device 710 can include, but are not limited to, a personal computer, a notebook computer, a networked personal digital assistant (PDA), a cellular phone, a two-way pager, and the like. The network 712 can include a local area network (LAN), a wide area network (WAN), a metro area network (MAN), the Internet, or a combination thereof. A variety of network mediums can be implemented in network 712, such as wire-based networks, fiber-optic networks, wireless networks, and the like.

In at least one embodiment, the performance management system 102 is adapted to maintain a website to receive business performance information and to provide one or more performance reports resulting from an analysis of the business performance information. The website may include a grouping of one or more webpages navigable by the web browser 714 of the network device 710. The webpages may include documents or other files adapted for display on the web browser 714 and preferably are capable of receiving input from a user of the network device 714 and providing a representation of this input to the performance analysis module 102 using HTTP or similar protocols. Representations of the webpages of the website may be transmitted to the network device 710 for display by the web browser 714 in the form of one or more data files or data streams. The data files may include any of a variety of file formats including, but not limited to, a Hypertext Markup Language (HTML) file, an Extensible Markup Language (XML) file, an Extensible Business Financial Reporting Language (XBRL) file, a Java Applet file, or other set of data sent using one or more protocols, such as Simple Object Access Protocol (SOAP), Open Data Base Connectivity (ODBC), Java Data Base Connectivity (JDBC), Active Server Pages (ASP) and the like.

The web browser 714 may include a software application adapted to display a graphical representation of a webpage and receive input via the webpage. Exemplary web browsers 714 include the NETSCAPE COMMUNICATOR web browser available from Netscape Communication Corp. of Mountain View Calif. and the INTERNET EXPLORER web browser available from Microsoft Corp. of Redmond, Wash.

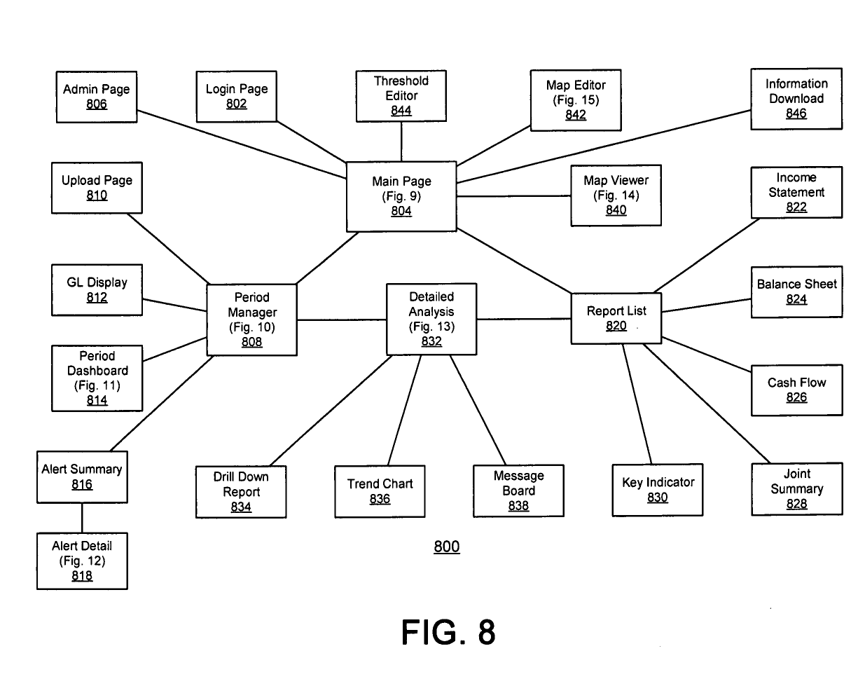

Referring now to FIG. 8, an exemplary site map of a website 800 maintained by the performance management system 102 (FIG. 1) is illustrated in accordance with at least one embodiment of the present invention. As noted above, the website 800 may include a plurality of webpages used to upload business performance information, generate and display performance reports, create and edit conversion maps, perform various administrative tasks, and the like. Although the exemplary website 800 is discussed below with particular reference to the management of financial information, the techniques described herein also may be applied to operational information management without departing from the spirit or scope of the present invention.

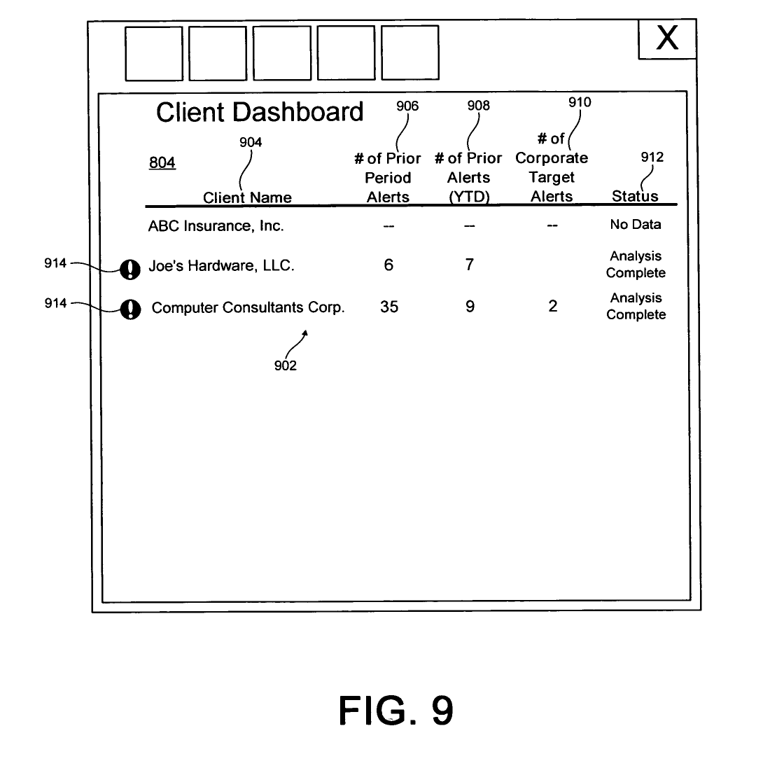

To access the website 800, the individual accessing the website (the “user”) typically is presented with a login webpage 802 whereupon the user provides a user ID and/or password for verification. Upon successful verification, the user is directed to a main webpage 804. The main webpage 804 typically acts as a hub wherein the user can access other webpages described herein. An exemplary main webpage 804 is illustrated with reference to FIG. 9. Various administrative tasks, such as adding and removing users, may be achieved via an administrative webpage 806.

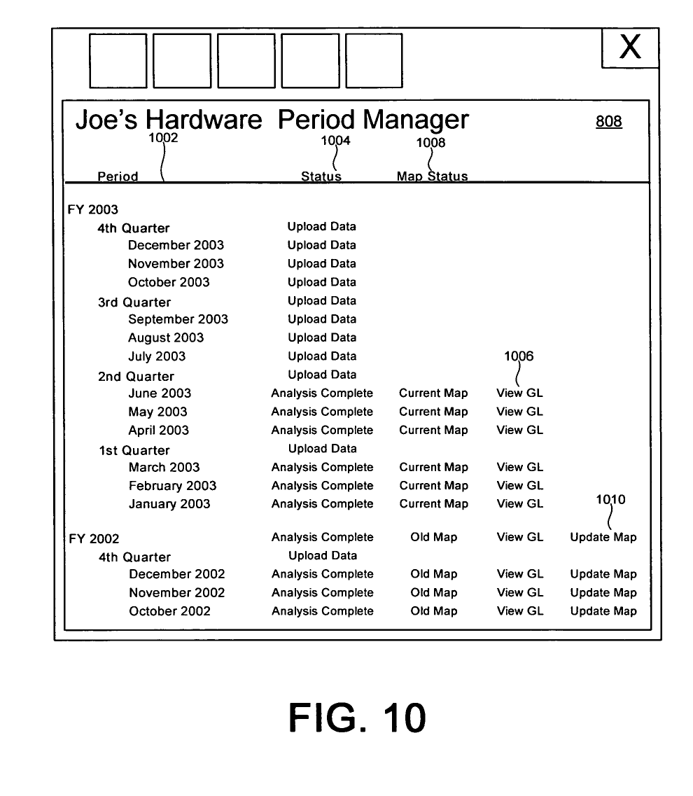

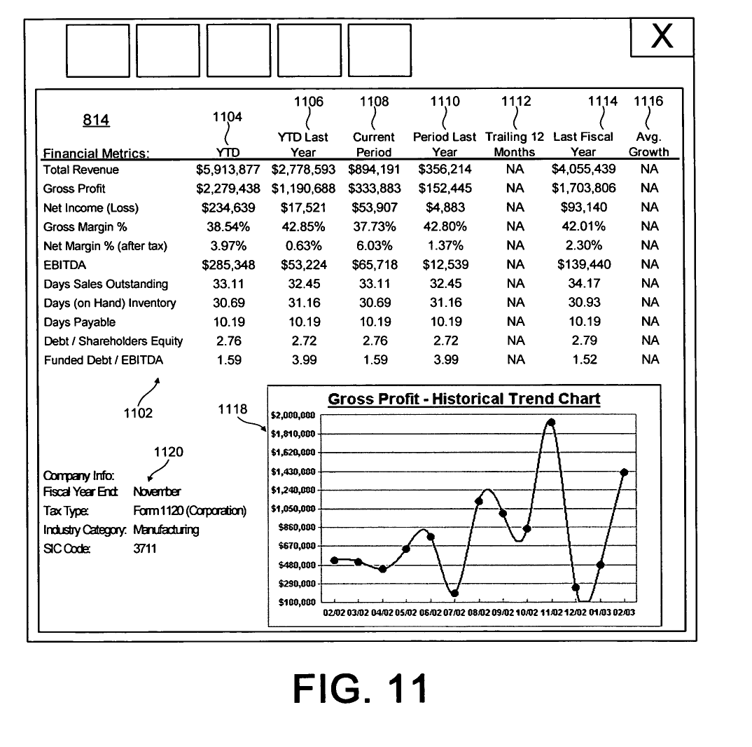

In one embodiment, the website 800 includes a period manager webpage 808 wherein a sequence of past financial periods or operational cycles for a business are listed. From this list, a particular financial period or operational cycle may be selected for review. An exemplary implementation of the period manager webpage 808 is illustrated with reference to FIG. 10. The website 800 further may include an upload page 810 wherein performance information for a certain financial period or operational cycle may be uploaded in any of a variety of electronic forms. A general ledger (GL) display webpage 812 may be used to display the general ledger for a financial period selected from the period manager webpage 808. Similarly, a period dashboard webpage 814 may be provided to display a summary of the performance of a business for a selected financial period or operational cycle. An exemplary implementation of the period dashboard webpage 814 is illustrated with reference to FIG. 11.

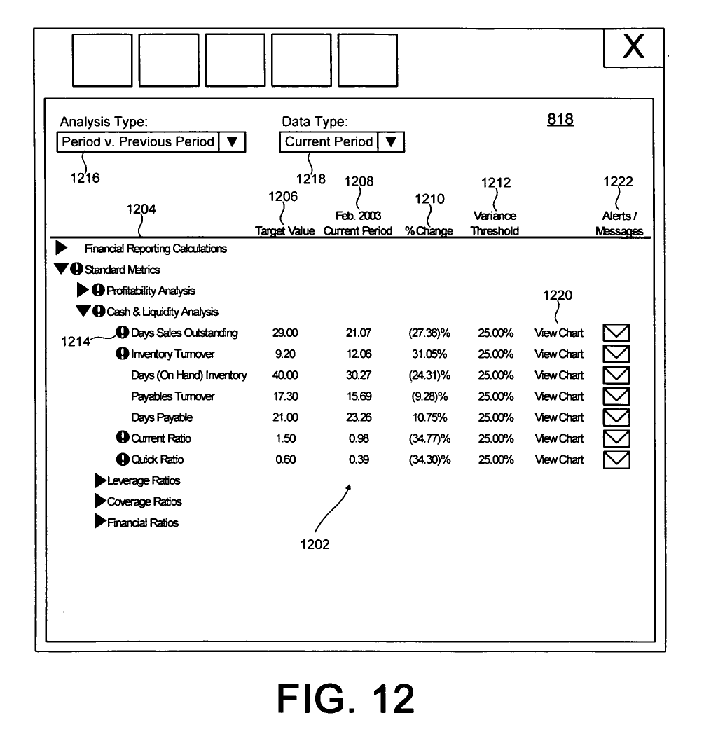

An alert summary webpage 816 may be provided to summarize the alert indicators present for a selected financial period. An alert detail webpage 818 may be used to provide additional detail regarding particular alert indicators. An exemplary implementation of the alert detail webpage 818 is illustrated with reference to FIG. 12.

The website 800 also may include a report list webpage 820 for listing various standard reports available for display, such as an income statement webpage 822 for displaying an income statement for a particular period, a balance sheet webpage 824 for displaying a balance sheet for a particular period, a cash flow webpage 826 for displaying a cash flow statement, a joint summary webpage 828 for displaying a summary of the income statement, the balance sheet and the cash flow statement, and a key indicator webpage 830 for displaying the values for one or more key performance metrics for a given period. Other performance reports may be displayed as appropriate.

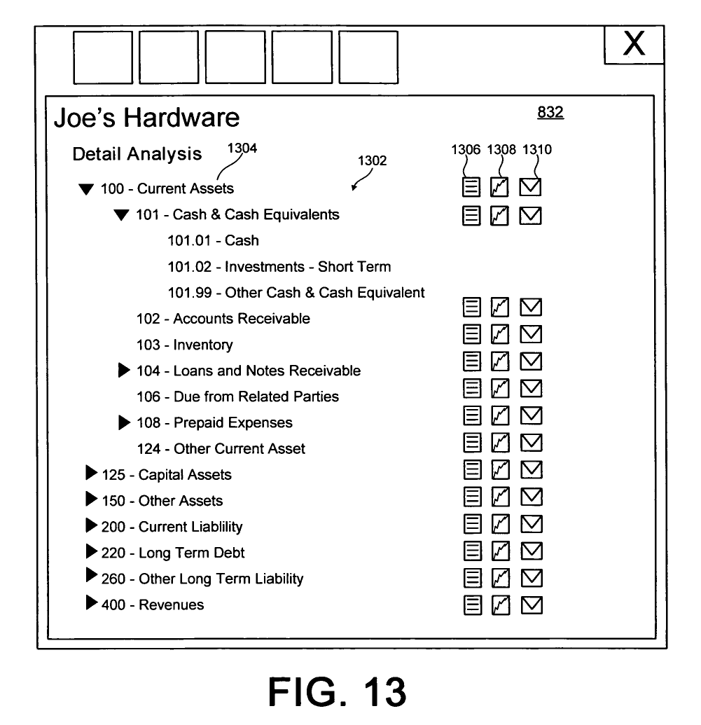

The website 800 further may include a detailed analysis webpage 832 for displaying performance information related to one or more items. Detailed information for an item may be provided via a drill down performance report webpage 834 for displaying a table of current and previous values for one or more items a trend chart webpage 836 for displaying a chart of current and previous values for one or more items, or a message board webpage 838 for inputting messages to discussing one or more items of interest. An exemplary implementation of the detailed analysis webpage 832 is discussed below with reference to FIG. 13.

As noted above, in at least one embodiment, one or more conversion maps are used to convert business performance information from a particular format to a standard format. The website 800 therefore may include a map viewer webpage 840 for viewing a representation of the conversion map for a business and a map editor webpage 842 for creating and editing a conversion map. An exemplary implementation of the map viewer webpage 840 is illustrated with reference to FIG. 14. An exemplary implementation of the map editor webpage 842 and an exemplary method of its operation are illustrated with reference to FIGS. 15 and 16.

The performance reports generated by the performance management system 102 may include alert indicators to identify items of particular interest. As described above, the alert indicators may be set when the variance of a performance metric from another value exceeds a certain threshold. Accordingly, the website 800 may include a threshold editor webpage 844 for setting the desired threshold value for some or all of the performance metrics.

As noted above, in at least one embodiment, representations of performance reports or the standardized performance information may be downloaded or otherwise transported to a requesting party via the website 800. Accordingly, the website 800 may implement an information download webpage 846 wherein a user may provide various information related to the desired information, such as information specifying a particular date range, a particular information type, the type of data file to be downloaded, and the like. The website 800 may use the provided parameters to identify the desired information, format it in the desired format, and provide it for download or transfer to the user.

Although FIG. 8 illustrates a number of exemplary webpages for implementation as part of website 800, using the teachings provided herein, those skilled in the art may implement alternate or additional webpages without departing from the spirit or the scope of the present invention. Furthermore, although various functions of the website 800 have been identified with a particular webpage, it will be appreciated that one or more functions may be implemented using a single webpage and that a single function may be implemented using multiple webpages.

Referring now to FIG. 9, an exemplary implementation of the main webpage 804 of the website 800 is illustrated in accordance with at least one embodiment of the present invention. In the illustrated example, the main webpage 804 includes a table 902 of businesses accessible to the user.

In addition to a listing of the business name (column 904), the table 902 may include the number of alert indicators for the previous financial period (column 906), the number of alert indicators for the year to date (YTD) (column 908), the number of alert indicators related to targets set by the business (column 910), as well as a status of the performance analysis of the business (column 912) used to indicate whether performance information for the current period has been uploaded, whether the analysis of uploaded performance information has been completed, and the like. Alert indicators (e.g., indicators 914) may be associated with one or more of the listed businesses to inform the user that one or more items of the corresponding performance information may warrant immediate or more thorough attention.

The user may proceed to access the business performance information and performance reports related to a listed business by selecting the business from the table 902 using any of a variety of standard GUI selection methods, including, for example, selecting hypertext associated with the listed business, selecting a button or checkbox associated with the listed business, selecting the business from a pull down list, and the like.

Referring now to FIG. 10, an exemplary implementation of the period manager webpage 808 of the website 800 is illustrated in accordance with at least one embodiment of the present invention. In the illustrated example, various financial periods or operational cycles are presented in a nested list (column 1002). For example, the first level of the nested list may represent the fiscal year periods, the second level may represent the quarterly periods of the corresponding fiscal year, and the third level may represent the monthly period of the corresponding quarterly period. Each financial period or operational cycle may have a corresponding status listed (column 1004), wherein the status may indicate whether performance information for the respective financial period or operational cycle has been uploaded to the performance management system 102 (FIG. 1). In the event that the performance information has not been uploaded for a certain period, the user may elect to select the financial period or operational cycle (e.g., by selecting a hypertext link associated with the status listing of the financial period or operational cycle) and initiate the upload process. For those periods or cycles having uploaded performance information, the status may indicate whether the performance analysis of the uploaded information is complete. If the performance analysis for a period is complete, the user may select the period to access the business performance information and various related performance reports. A user also may elect to view the general ledger (GL) for a particular period by selecting the corresponding “view GL” link (column 1006).

In certain instances, the conversion map used to convert the business performance information of a business to a standard format may change due to changes in the user-defined format, the standard format, or both. Accordingly, each period or cycle may have an indication (column 1008) of the version of the conversion map used to convert the uploaded performance information to a standard format. In event that the conversion map is not the most recent version, the user may elect to update the conversion map or create a new conversion map by, for example, selecting the corresponding “update map” hypertext link (column 1010). The creation and modification of conversion maps is discussed in greater detail below.

Referring now to FIG. 11, an exemplary implementation of the period dashboard webpage 814 for a certain financial period (e.g., February 2003) is illustrated in accordance with at least one embodiment of the present invention. In the illustrated example, the period dashboard webpage 814 includes a performance metric table 1102 listing various performance metrics (financial metrics in the illustrated example), such as, for example, total revenue, gross profit, net income, gross margin, net margin after tax, earnings before interest, taxes, depreciation and amortization (EBITDA), days sales outstanding, days inventory, days payable, debt to shareholder's equity ratio, funded debt to EBITDA ratio, and the like. Various values for each financial metric may be shown, such as the YTD value (column 1104), the YTD value for the previous year (column 1106), the value for the current period (column 1108), the value for the same period for the previous year (column 1110), a trailing period (column 1112), the last fiscal year (column 1114), as well as an indication of the growth or decline of the value (column 1116).

In addition, the period dashboard webpage 814 may display one or more charts 1118 detailing a historical trend for one or more financial metrics. For example, to view a trend chart of one of the financial metrics listed in the table 1102, the user may select a link associated with the financial metric to initiate the display of a corresponding chart 1118 for the selected financial metric. The webpage 814 further may include, for example, a business information table 1120 providing general information about the business, such as, for example, the fiscal year end, the tax type of the business, the industry category, and the like.

Referring now to FIG. 12, an exemplary implementation of the alert detail webpage 818 of the website 800 is illustrated in accordance with at least one embodiment of the present invention. In the illustrated example, the alert detail webpage 818 depicts a table 1202 having a nested list of various performance metrics (column 1204), along with the corresponding target value (column 1206), the corresponding actual value for the period (column 1208), the percent change between of the current period and the previous period or the percent difference between the current period and the corresponding target value (column 1210) and the threshold variance set for the corresponding metric (column 1212). In the event that the percent change or percent difference (column 1210) for a performance metric exceeds the corresponding threshold (column 1212), an alert indicator 1214 (e.g., an icon) may be associated with the performance metric on the webpage 818 and/or an alert may be transmitted to one or more parties. The appearance of the alert indicator 1214 may be altered depending on whether the variance represents a positive or negative event. For example, a red colored alert indicator 1214 may be used to indicate when the total cost of revenue has exceeded a predetermined target by the selected threshold. Conversely, a green colored alert indicator 1214 may be used to indicate when the net profit has exceeded the predetermined target by the selected threshold.

The webpage 818 further may include an analysis type selector 1216 (e.g., a pull-down list) to enable the selection of the analysis type for alerting purposes (e.g., a comparison of the current period to a previous period or a comparison of the current period to the target values). A data type selector 1218 may be displayed to enable the selection of the period to be analyzed (e.g., the current period or YTD). The table 1202 further may include links to view value tables for the corresponding performance metrics (column 1220) or a link to a message board for the addition of messages to discuss a certain performance metric (column 1222).

Referring now to FIG. 13, an exemplary implementation of the detail analysis webpage 832 of the website 800 is illustrated in accordance with at least one embodiment of the present invention. In the illustrated example, the webpage 832 depicts a table 1302 having a nested list (column 1304) of various hierarchical performance classifications of the standard format used by the performance management system 102 (FIG. 1). For certain performance classifications, the user may elect to view the raw data related to the performance classification in a list or chart format by, for example, selecting the corresponding list icon 1306 or chart icon 1308, respectively. The user also may select the corresponding icon 1310 to submit a message to a message board associated with the class or subclass.

Referring now to FIG. 14, an exemplary map viewer webpage 842 is illustrated in accordance with at least one embodiment of the present invention. In the illustrated embodiment, the webpage 842 depicts a table 1402 listing the performance classifications of the user-defined format used by a business by account number (column 1404) and account description (column 1406). The correlated account of the standard format is listed in the same row by map account number (column 1408) and map account description (column 1410). The table 1402 further may include a current value for the standard performance classifications (column 1412). Those user-defined performance classifications that have not been mapped may be indicated as such. For example, the user-defined account “Employee Advances: Temp” (account no. 050-000-00) has not yet been mapped to a standard account in the illustration of FIG. 14.

Referring now to FIGS. 15 and 16, an exemplary implementation of the map editor webpage 842 and an exemplary method 1600 for creating or editing a conversion map are illustrated in accordance with at least one embodiment of the present invention. In the illustrated example of FIG. 15, the map editor webpage 842 includes a table 1502 listing the user-defined performance classification by, for example, account number (column 1504) and description (column 1506). For each user-defined performance classification, the table 1502 may further include an identifier (column 1508) of the standard performance classification, if any, to which the user-defined performance classification is correlated. The table 1502 also may include a description (not shown) of the correlated standard performance classification. In the illustrated example, the identifier includes the map number of the corresponding standard performance classification. Those user-defined performance classifications that have not been mapped to a standard performance classification may be marked as such. The webpage 842 further may include a nested list 1510 listing some or all of the standard performance classifications to which user-defined performance classifications may be mapped.

FIG. 16 illustrates an exemplary method to generate a conversion map using the webpage 842 of FIG. 15 or a similar GUI. The method 1600 initiates at step 1602 wherein a list of user-defined performance classifications are listed, such as in table 1502. At step 1604, some or all of the standard performance classifications are listed, such as in nested list 1510. At step 1606, the user provides input that indicates correlations between one or more user-defined performance classifications and a standard performance classification. To illustrate, the user may select the appropriate user-defined performance classifications by selecting a check box 1512 next to each of the selected user-defined performance classifications and then selecting a map icon 1514 associated with the standard performance classification to which the selected user-defined performance classifications are to be mapped. For example, to map the user-defined account “Due from Shareholders” (account number 200-010) to the standard account “Due from Shareholders (map account number 105), the user may select the checkbox 1512 adjacent to the row of table 1502 listing account number 200-010 and then selecting the map icon 1514 adjacent to the row of the nested list 1510 that lists account number 105. Upon receipt of this input, the performance management system 102 at step 1608 creates or modifies a conversion map associated with the business to reflect the correlation between the one or more user-defined performance classifications and the standard performance classification or classification. The conversion map then may be used to convert business performance information from the particular format to a standard format.

To modify the standard format to include additional performance classifications, a user may select, for example, an add account icon 1516 to create a sub-account in the corresponding account. For example, the account “cash & cash equivalents” (account number 101) is illustrated as having sub-accounts for “cash,” “investments-short term,” and “other cash & cash equivalents.” To create an additional sub-account for the “cash & cash equivalents” account, the user may select the add account icon 1516 adjacent to the listing for the “cash & cash equivalents” account to cause the display of a form whereby new account information may be entered to generate a new account.

Referring now to FIG. 17, an exemplary implementation of an alert as an alert email 1700 is illustrated in accordance with at least one embodiment of the present invention. As noted above, one or more alerts may be provided via email, fax, recorded voice message, and the like. The generation and provision of reports may be automated by the system 102, such as for example, when a particular performance metric exceeds a related threshold. In another embodiment, an alert indicator may be provided to an agent of a requesting party or the submitting party (e.g., a CPA) and the agent may initiate the transmission of an alert to the submitting party or another requesting party through, for example, the website 800. The alert may be used to notify the submitting party of an issue that needs attention, to provide a proposed solution, an offer for help, and the like.

In at least one embodiment, the alert is transmitted as an alert email 1700. As the example of FIG. 17 illustrates, the alert email 1700 may include an alert topic field 1702, an alert description field 1704, a comments field 1706, a display of a trend chart or other graphic associated with the alert (or a link 1708 to the trend chart or graphic), a link 1710 for replying to the alert email through the performance management system 102 (FIG. 1), a link 1712 to the website 800 (FIG. 8), and the like.

As described above, FIGS. 1-17 illustrate various exemplary systems and methods for the management of business performance information. The hardware portions of the systems disclosed herein may be in the form of a “processing device,” such as a microprocessor, microcontroller, application specific integrated circuit, or a programmable logic controller, for example. Further, various components of the systems and/or steps of the exemplary methods described herein may be implemented as a set of executable instructions (i.e., software) executed by a processing component of the respective system. The instructions may be either permanently or temporarily stored in memory of the respective system. The set of instructions may include various instructions that perform a particular task or tasks, such as those tasks described above with reference to the exemplary methods. Such a set of instructions for performing a particular task may be characterized as a program, software program, or simply software. The software may be in the form of, for example, system software or application software. The software might also be in the form of a collection of separate programs, a program module within a larger program, or a portion of a program module. The software used might also include modular programming in the form of object-oriented programming.

Further, it is appreciated that the instructions or set of instructions used in the implementation and operation of the invention may be in a suitable form such that a processor or other processing component may read the instructions. For example, the instructions that form a program may be in the form of a suitable programming language, which is converted to machine language or object code to allow the processing component to perform the instructions. That is, written lines of programming code or source code, in a particular programming language, are converted to machine language using a compiler, assembler or interpreter. The machine language is binary coded machine instructions that are specific to a particular type of processing device, i.e., to a particular type of computer, for example. Any suitable programming language may be used in accordance with the various embodiments of the invention. Further, it is not necessary that a single type of instructions or single programming language be utilized in conjunction with the operation of the system and method of the invention. Rather, any number of different programming languages may be utilized as is necessary or desirable.

Other embodiments, uses, and advantages of the invention will be apparent to those skilled in the art from consideration of the specification and practice of the invention disclosed herein. The specification and drawings should be considered exemplary only, and the scope of the invention is accordingly intended to be limited only by the following claims and equivalents thereof.

1. A method for automated management of performance information associated with at least one business, the method comprising:
obtaining performance information associated with a business, the performance information having a first format based on a first set of performance classifications;
converting, using an automated process, the performance information from the first format to a second format based at least in part on a mapping of one or more performance classifications of the first set of performance classifications to one or more respective performance classifications of a second set of standardized performance classifications; and
analyzing the converted performance information based at least in part on one or more performance metrics.

2. The method as in claim 2, further comprising:
generating one or more performance reports based on the analysis of the converted performance information.

3. The method as in claim 2, wherein the one or more performance reports includes at least one alert indicator to identify at least one performance metric of the converted performance information having a variance from a corresponding predetermined value that exceeds a threshold associated with the at least one performance metric.

4. The method as in claim 3, wherein the predetermined value includes a value of the performance metric from a previous period.

5. The method as in claim 3, wherein the predetermined value includes a target value set for the at least one performance metric.

6. The method as in claim 3, wherein the predetermined value includes a value representative of an industry average for the at least one performance metric.

7. The method as in claim 1, further comprising the steps of:
obtaining performance information associated with a second business, the performance information having a third format based on a third set of performance classifications;
converting, using an automated process, the performance information associated with the second business from the third format to the second format based at least in part on a mapping of one or more performance classifications of the third set of performance classifications to one or more respective performance classifications of the second set of performance classifications; and
analyzing the converted performance information associated with the second business based at least in part on one or more performance metrics.

8. The method as in claim 7, further comprising:
generating one or more performance reports based on results of the analysis of the converted performance information associated with the second business.

9. The method as in claim 7, further comprising:
aggregating the converted performance information associated with the first and second businesses; and
analyzing a performance of at least one of the first and second businesses based on one or more representative performance metrics from the aggregated converted performance information.

10. The method as in claim 1, wherein obtaining the performance information includes receiving the performance information as one or more data files uploaded via a website.

11. The method as in claim 1, further comprising providing the one or more performance reports to at least one requesting party.

12. The method as in claim 11, wherein the one or more performance reports are provided via a website.

13. The method as in claim 1, wherein the conversion of the performance information from the first format to the second format is performed at least in part using one or more software programs.

14. The method as in claim 13, wherein the performance information is converted from the first format to the second format using a conversion map indicating correlations between performance classifications of the first set of performance classifications and performance classifications of the second set of performance classifications.

15. The method as in claim 1, wherein the business is one of a group consisting of: a private business; a public business; a non-profit organization; and a government agency.

16. The method as in claim 1, further comprising:
providing at least one alert to at least one requesting party, the alert identifying at least one performance metric of the converted performance information having a variance from a corresponding predetermined value that exceeds a threshold associated with the at least one performance metric.

17. The method as in claim 16, wherein the predetermined value includes a value of the performance metric from a previous period.

18. The method as in claim 16, wherein the predetermined value includes a target value set for the at least one performance metric.

19. The method as in claim 16, wherein the predetermined value includes a value representative of an industry average for the at least one performance metric.

20. The method as in claim 16, wherein the alert is delivered via at least one of a group comprising: an email; a facsimile; a voice message; and a text message.

21. The method as in claim 1, further comprising:
delivering at least a portion of the converted performance information to a requesting party as one or more data files having a format compatible with software operated by the requesting party.

22. The method as in claim 1, wherein the performance information includes financial information and where one or more of the performance classifications of the first set of performance classifications includes a financial account and one or more of the performance classifications of the second set includes a financial account correlated to a financial account of the first set.

23. The method as in claim 1, wherein the performance information includes operational information and where one or more of the performance classifications of the first set of performance classifications includes an operational classification and one or more of the performance classifications of the second set includes an operational classification correlated to a operational classification of the first set.

24. A method for automated management of performance information associated with at least one business, the method comprising:
obtaining performance information associated with a business as electronic data uploaded via a graphical user interface (GUI), the performance information having a first format based on a first set of performance classifications;
converting, using at least one automated software program associated with the GUI, the performance information from the first format to a second format based at least in part on a mapping of the one or more performance classifications of the first set of performance classifications to one or more corresponding performance classifications of a second set of performance classifications;
analyzing, using at least one automated software program associated with the GUI, the converted performance information based at least in part on one or more performance metrics; and
displaying one or more performance reports based on results of the analysis of the converted performance information via the GUI.

25. The method as in claim 24, wherein the GUI includes one or more webpages of a website.

26. The method as in claim 24, wherein the performance information is converted from the first format to the second format using a conversion map indicating correlations between performance classifications of the first set of performance classifications and performance classifications of the second set of performance classifications.

27. The method as in claim 24, wherein the business is one of a group consisting of: a private business; a public business; a non-profit organization; and a government agency.

28. The method as in claim 24, further comprising:
providing a least one alert to at least one requesting party via the website, the alert identifying at least one performance metric of the converted performance information having a variance from a corresponding predetermined value that exceeds a threshold associated with the at least one performance metric.

29. The method as in claim 28, wherein the alert is delivered from the website via at least one of a group comprising: an email; a facsimile; a voice message; and a text message.

30. The method as in claim 24, further comprising:
delivering at least a portion of the converted performance information to a requesting party via the website as one or more data files having a format compatible with software operated by the requesting party.

31. The method as in claim 24, wherein the performance information includes financial information and where one or more of the performance classifications of the first set of performance classifications includes a financial account and one or more of the performance classifications of the second set includes a financial account correlated to a financial account of the first set.

32. The method as in claim 24, wherein the performance information includes operational information and where one or more of the performance classifications of the first set of performance classifications includes an operational classification and one or more of the performance classifications of the second set includes an operational classification correlated to a operational classification of the first set.

33. A system for automated management of performance information associated with at least one business, the system comprising:
means for obtaining performance information associated with a business, the performance information having a first format based on a first set of performance classifications;
automated means for converting the performance information from the first format to a second format based at least in part on a mapping of one or more performance classifications of the first set of performance classifications to one or more performance classifications of a second set of performance classifications; and
automated means for analyzing the converted performance information based at least in part on one or more performance metrics.

34. The system as in claim 33, further comprising:
automated means for generating one or more performance reports based on results of the analysis of the converted performance information.

35. The system as in claim 34, wherein the one or more performance reports includes at least one alert indicator to identify at least one performance metric of the converted performance information having a variance from a corresponding predetermined value that exceeds a threshold associated with the performance metric.

36. The system as in claim 34, wherein the predetermined value includes a value of the performance metric from a previous period.

37. The system as in claim 34, wherein the predetermined value includes a target value set for the performance metric.

38. The system as in claim 34, wherein the predetermined value includes a value representative of an industry average for the performance metric.

39. The system as in claim 33, further comprising:
means for obtaining performance information associated with a second business, the performance information having a third format based on a third set of performance classifications;
automated means for converting the performance information associated with the second business from the third format to the second format based at least in part on a mapping of one or more performance classifications of the third set of performance classifications to one or more respective performance classifications of the second set of performance classifications; and
automated means for analyzing the converted performance information associated with the second business.

40. The system as in claim 39, further comprising:
automated means for generating one or more performance reports based on results the analysis of the converted performance information associated with the second business.

41. The system as in claim 39, further comprising:
means for aggregating the converted performance information associated with the first and second businesses; and
means for analyzing a performance of at least one of the first and second businesses based on one or more representative performance metrics from the aggregated converted performance information.

42. The system as in claim 33, wherein the means for obtaining the performance information includes a website adapted to receive the performance information as one or more uploaded data files.

43. The system as in claim 33, further comprising means for providing the one or more performance reports to at least one requesting party.

44. The system as in claim 43, wherein the means for providing the one or more performance reports includes a website adapted to provide the one or more performance reports as one or more webpages.

45. The system as in claim 33, wherein the automated means for converting the performance information from the first format to the second format includes one or more software programs adapted to convert the performance information using a conversion map indicating correlations between performance classifications of the first set of performance classifications and performance classifications of the second set of performance classifications.

46. The system as in claim 33, wherein the business is one of a group consisting of: a private business; a public business; a non-profit organization; and a government agency.

47. The system as in claim 33, further comprising:
means for providing at least one alert to at least one requesting party, the alert identifying at least one performance metric of the converted performance information having a variance from a corresponding predetermined value that exceeds a threshold associated with the at least one performance metric.

48. The system as in claim 47, wherein the predetermined value includes a value of the performance metric from a previous period.

49. The system as in claim 47, wherein the predetermined value includes a target value set for the at least one performance metric.

50. The system as in claim 47, wherein the predetermined value includes a value representative of an industry average for the at least one performance metric.

51. The system as in claim 47, wherein the alert is delivered via at least one of a group comprising: an email; a facsimile; a voice message; and a text message.

52. The system as in claim 33, further comprising:
means for delivering at least a portion of the converted performance information to a requesting party as one or more data files having a format compatible with software operated by the requesting party.

53. The system as in claim 33, wherein the performance information includes financial information and where one or more of the performance classifications of the first set of performance classifications includes a financial account and one or more of the performance classifications of the second set includes a financial account correlated to a financial account of the first set.

54. The system as in claim 33, wherein the performance information includes operational information and where one or more of the performance classifications of the first set of performance classifications includes an operational classification and one or more of the performance classifications of the second set includes an operational classification correlated to a operational classification of the first set.

55. A system for automated management of performance information associated with a at least one business, the system comprising:
one or more networked servers adapted to:
operate a website having one or more webpages;
obtain performance information associated with a business as electronic data uploaded via one or more webpages of the website, the performance information having a first format based on a first set of performance classifications;
convert the performance information from the first format to a second format based at least in part on a mapping between one or more performance classifications of the first set of performance classifications to one or more respective performance classifications of the second set of performance classifications;
analyze the converted performance information based at least in part on one or more performance metrics; and
provide one or more performance reports of results of the analysis of the converted performance information for display via the one or more webpages of the website.

56. The system as in claim 55, wherein the one or more networked servers are adapted to convert the performance information using a conversion map indicating correlations between one or more performance classifications of the first set of performance classifications and one or more respective performance classifications of the second set of performance classifications.

57. The system as in claim 55, wherein the one or more networked servers are further adapted to:
obtain performance information associated with a second business as electronic data uploaded via one or more webpages of the website, the performance information associated with the second business having a third format based on a third set of performance classifications;
convert the performance information associated with the second business from the third format to the second format based at least in part on a mapping between one or more performance classifications of the third set of performance classifications to one or more-respective performance classifications of the second set of performance classifications;
analyze the converted performance information associated with the second business based at least in part on one or more performance metrics; and
provide for the display of one or more performance reports of results of the analysis of the converted performance information associate with the second business via the one or more webpages of the website.

58. The system as in claim 55, wherein the business is one of a group consisting of: a private business; a public business; a non-profit organization; and a government agency.

59. The system as in claim 55, wherein the one or more networked servers are further adapted to:
provide a least one alert to at least one requesting party via the website, the alert identifying at least one performance metric of the converted performance information having a variance from a corresponding predetermined value that exceeds a threshold associated with the at least one performance metric.

60. The system as in claim 59, wherein the alert is delivered from the website via at least one of a group comprising: an email; a facsimile; a voice message; and a text message.

61. The method as in claim 55, wherein the one or more networked servers are further adapted to:
deliver at least a portion of the converted performance information to a requesting party via the website as one or more data files having a format compatible with software operated by the requesting party.

62. The system as in claim 55, wherein the performance information includes financial information and where one or more of the performance classifications of the first set of performance classifications includes a financial account and one or more of the performance classifications of the second set includes a financial account correlated to a financial account of the first set.

63. The system as in claim 55, wherein the performance information includes operational information and where one or more of the performance classifications of the first set of performance classifications includes an operational classification and one or more of the performance classifications of the second set includes an operational classification correlated to a operational classification of the first set.

64. A method for mapping business performance information having a first format based on a first set of performance classifications to a second format based on a second set of performance classifications, the method comprising:
displaying a list of one or more performance classifications of the first set of performance classifications via a graphical user interface (GUI);
displaying a list of one or more of performance classifications of the second set of performance classifications via the GUI;
receiving user input indicating correlations between one or more of the displayed performance classifications of the first set of performance classifications and one or more of the displayed performance classifications of the second set of performance classifications; and
generating a conversion map for converting the business performance information from the first format to the second format based at least in part on the correlations indicated by the user input.

65. The method as in claim 64, further comprising converting the business performance information from the first format to the second format using the conversion map.

66. The method as in claim 65, wherein the business performance information is converted from the first format to the second format using one or more automated software programs.

67. The method as in claim 64, further comprising:
obtaining additional business performance information having the first format; and
converting the additional business performance information from the first format to the second format using the conversion map.

68. The method as in claim 64, wherein the conversion map is generated using one or more automated software programs associated with the GUI.

69. The method as in claim 64, wherein the GUI includes one or more webpages of a website.

70. A system for mapping business performance information having a first format based on a first set of performance classifications to a second format based on a second set of performance classifications, the system comprising:
means for displaying a list of one or more performance classifications of the first set of performance classifications on a graphical user interface (GUI);
means for displaying a list of one or more of performance classifications of the second set of performance classifications on the GUI;
means for receiving user input indicating correlations between one or more of the displayed performance classifications of the first set of performance classifications and one or more displayed performance classifications of the second set of performance classifications; and
means for generating a conversion map for converting the business performance information from the first format to the second format based at least in part on the corrlations indicated by the user input.

71. The system as in claim 70, further comprising automated means for converting the business performance information from the first format to the second format using the conversion map.

72. The system as in claim 70, further comprising:
means for obtaining additional business performance information having the first format; and
automated means for converting the additional business performance information from the first format to the second format using the conversion map.

73. The system as in claim 70, wherein the GUI includes one or more webpages of a website.

74. A method for providing a benchmark analysis of performance information associated with at least one business, the method comprising:
converting performance information associated with each of a plurality of businesses to a first format;
aggregating at least a portion of the converted performance information of each of the plurality of businesses;
identifying one or more representative performance metrics representative of the plurality of businesses based at least in part on an analysis of the aggregated performance information; and
benchmarking performance information associated with a first business based at least in part on a comparison of the performance information associated with the first business with at least one of the one or more representative performance metrics.

75. The method as in claim 74, further comprising converting the performance information associated with the first business to the first format and wherein the converted performance information associated with the first business is compared with the at least one of the one or more representative performance metrics.

76. The method as in claim 74, further comprising generating one or more performance reports based at least in part on results of the comparison of the performance information associated with the first business with the at least one representative performance metric.

77. The method as in claim 74, wherein the one or more performance reports includes at least one alert indicator to identify at least one performance metric of the performance information associated with the first business that has a variance from a corresponding representative performance metric that exceeds a threshold associated with the performance metric.

78. The method as in claim 74, wherein at least one of the steps of converting, aggregating, identifying and analyzing are performed at least in part using one or more automated software programs.

79. The method as in claim 74, wherein at least one business of the plurality of businesses is a private business.

80. The method as in claim 79, wherein the first business is a private business.

81. The method as in claim 79, wherein the first business and the plurality of businesses have one or more business classifications in common.

82. The method as in claim 79, wherein the one or more business classifications include at least one of a group consisting of: a similar industry type; a similar size; a similar revenue; a similar asset value; a same business entity type; a similar stage of maturity; and a similar geographical location.

83. The method as in claim 79, wherein the performance information includes financial information and where one or more of the performance classifications includes a financial account.

84. The method as in claim 79, wherein the performance information includes operational information and where one or more of the performance classifications includes an operational classification.

85. A method for providing a benchmark analysis of performance information associated with at least one business, the method comprising:
converting performance information associated with a first business from a first format based on a first set of performance classifications to a second format based on a second set of performance classifications;
comparing the converted performance information with performance information associated with a second business and having the second format, wherein the second business has at least one business classification in common with the first business; and
generating one or more performance reports based at least in part on results of the comparison.

86. The method as in claim 85, further comprising the step of converting the performance information associated with the second business from a third format based on a third set of performance classifications to the second format.

87. The method as in claim 85, wherein the steps of converting, comparing and generating are performed at least in part using one or more automated software programs.

88. The method as in claim 85, further comprising providing the one or more performance reports for display via one or more webpages of a website.

89. The method as in claim 85, wherein the first business and second businesses are private businesses.

90. A system for providing a benchmark analysis of performance information associated with a business, the system comprising:
a database having performance information associated with a plurality of businesses, the performance information having a first format based on a first set of performance classifications;
automated means for identifying one or more representative performance metrics representing the plurality of businesses based at least in part on an analysis of the performance information of the database; and
automated means for benchmarking performance information associated with a first business based at least in part on a comparison of the performance information of the first business with at least one of the one or more representative performance metrics.

91. The system as in claim 90, further comprising automated means for generating one or more performance reports based at least in part on results of the comparison of the performance information associated with the first business with the at least one representative performance metric.

92. The system as in claim 91, further comprising means for providing the one or more performance reports for display via one or more webpages of a website.

93. The system as in claim 90, further comprising automated means for converting the performance information associated with the first business from a second format based on a second set of performance classifications to the first format.

94. The system as in claim 90, wherein the each business of the plurality of businesses is a private business.

95. The method as in claim 94, wherein the first business is a private business.

96. The system as in claim 90, wherein the first business and the plurality of businesses have one or more business classifications in common.

97. The method as in claim 90, wherein the one or more business classifications include at least one of a group consisting of: a similar industry type; a similar size; a similar revenue; a similar asset value; a same business entity type; a similar stage of maturity; and a similar geographical location.

98. The method as in claim 90, wherein the performance information includes financial information and where one or more of the performance classifications includes a financial account.

99. The method as in claim 90, wherein the performance information includes operational information and where one or more of the performance classifications include an operational classification.
